(19) United States
(12) Patent Application Publication
(10) Pub. No.: US 2023/0258167 A1
(43) Pub. Date: Aug. 17, 2023

(54) AIR FILTER APPARATUS

(71) Applicant: Vortech Engineering, Inc., Oxnard, CA (US)

(72) Inventor: James Middlebrook, Santa Rosa Vallley, CA (US)

(73) Assignee: Vortech Engineering, Inc., Oxnard, CA (US)

(21) Appl. No.: 17/674,821

(22) Filed: Feb. 17, 2022

(51) Int. Cl. F04B 41/02; F04B 39/12

(52) U.S. Cl. CPC F04B 41/02; F04B 39/121

(57) ABSTRACT

An air filter apparatus is provided. The air filter apparatus includes a manifold having at least one compressible gas inlet and an outlet. The internal volume of the manifold increases from a distal end of the manifold to the outlet. A shroud is detachably mounted to the manifold so that a compressible gas can enter the shroud and pass through the at least one compressible gas inlet and through the outlet.

### FIELD OF THE INVENTION

The present invention generally relates to air compressor filters and more particularly, but not exclusively, to filters used immediately upstream of industrial air compressors.

### BACKGROUND OF THE INVENTION

Providing effective filtering for air compressor systems remains an area of interest. In dusty environments, the level of ambient particulates can be substantial, quickly clogging an exposed air intake filter. Frequent cleaning or replacement of this air intake filter is common in these environments. Undesirable buildup of particles upon the air intake filter may lead to malfunction of the air compressor and/or the motor assembly. As such, there is a need to effectively separate or reduce dust and particulates from entering the air intake filter. Accordingly, there remains a need for further contributions in this area of technology.

The discussion of the background to the invention included herein is included to explain the context of the invention. This is not to be taken as an admission that any of the material referred to was published, known or part of the common general knowledge as of the priority date of the claims.

### BRIEF DESCRIPTION OF THE DRAWINGS

FIG. 1 is an illustration of an air filter apparatus embodying the principals of the invention, removably coupled to a compressor;

FIG. 2 depicts elements of the air filter apparatus shown in FIG. 1;

FIG. 3 depicts a manifold element that is included in the air filter apparatus shown in FIG. 1;

FIG. 4 depicts an elevation view from the outlet end of the air filter apparatus shown in FIG. 1;

FIG. 5 depicts a lengthwise sectional view taken along cutting plane A-A shown in FIG. 4;

FIG. 6 depicts three sectional views taken along cutting planes B-B, C-C and D-D shown in FIG. 5; and

FIG. 7 depicts a bottom plan view from the outlet end of the air filter apparatus shown in FIG. 1.

It will be recognized that some or all the Figures are schematic representations for purposes of illustration and do not necessarily depict the actual relative sizes or locations of the elements shown. Unless otherwise specifically noted, articles depicted in the drawings are not necessarily drawn to scale. The Figures are provided for the purpose of illustrating one or more embodiments of the invention with the explicit understanding that they will not be used to limit the scope or the meaning of the claims.

### DETAILED DESCRIPTION OF THE PREFERRED EMBODIMENTS

In the following description, for the purposes of explanation, numerous specific details are set forth to provide a thorough understanding of the air filter apparatus (“AFA”) that embodies principals of the present invention. It will be apparent, however, to one skilled in the art that the AFA may be practiced without some of these specific details. Throughout this description, the embodiments and examples shown should be considered as exemplars, rather than as limitations on the AFA. That is, the following description provides examples, and the accompanying drawings show various examples for the purposes of illustration. However, these examples should not be construed in a limiting sense as they are merely intended to provide examples of the AFA rather than to provide an exhaustive list of all possible implementations of the AFA.

Specific embodiments of the AFA will now be further described by the following, non-limiting examples which will serve to illustrate various features. The examples are intended merely to facilitate an understanding of ways in which the invention may be practiced and to further enable those of skill in the art to practice the invention. Accordingly, the examples should not be construed as limiting the scope of the invention. In addition, reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

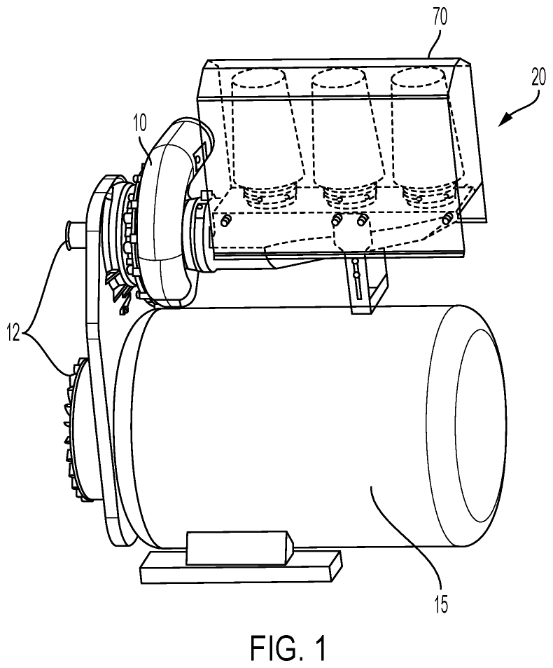

With reference to FIG. 1, a compressor system is shown which includes a compressor 10 that is run by a drive assembly 12 that is driven a motor (not shown) located within an enclosure 15. The compressor 10 can take on any form of compressor including screw compressors, centrifugal compressors, etc. and can be driven by any variety of motors or engines, with an electric motor being just one non-limiting example. A flow of compressible fluid, such as but not limited to air, is received by the compressor 10 and compressed and discharged as compressed fluid. For example, the compressor 10 may be coupled to a drive assembly 12 that is driven by a suitable sized electric motor that drives the compressor 10 so that the compressor 10 produces 2,500 cubic-feet-per-minute of compressed air.

As shown in FIGS. 1-7, the air filter apparatus (“AFA”) 20 is removably coupled to the compressor 10 by a sleeve 25 of any desired length, which may be flexible or rigid. The sleeve 25 is removably coupled to the compressor 10 by clamp 30 or any other type of fastener and is also removably coupled to the AFA outlet 35 by a similar clamp 30. It will be appreciated that other embodiments of the AFA 20 may include a sleeve 25 that is integral to the outlet 35. Also, the diameter of the outlet 35 may vary in different embodiments of the AFA 20.

Conventional compressor systems deliver vast amounts of air, as discussed above, but the air filters employed by them are insufficient as they choke or otherwise reduce the volume of air reaching the compressor inlet. Put differently, conventional air filters impede airflow to the compressor inlet, thereby reducing the volume of air that can be compressed, which decreases the efficiency of the compressor system. The amount of choke can be shown by comparing the ambient air pressure difference between the upstream and downstream sides of the air filter.

The AFA 20 as disclosed herein eliminates the deficiencies of conventional compressor air filter systems. The AFA 20 is structured to minimize choke to the compressor inlet by including several novel features. For example, the shape of the AFA 20 manifold 40 generates a smooth and uniform air flow to minimize turbulence, thereby increasing efficiency. In addition, the compact arrangement of filters 45 provides a large amount of filter surface area in a small space, thereby enabling installation in a wide variety of locations.

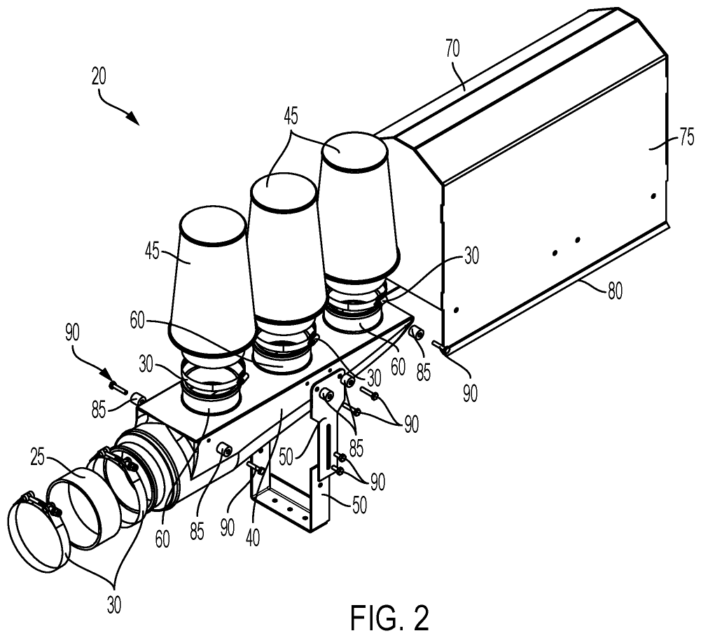

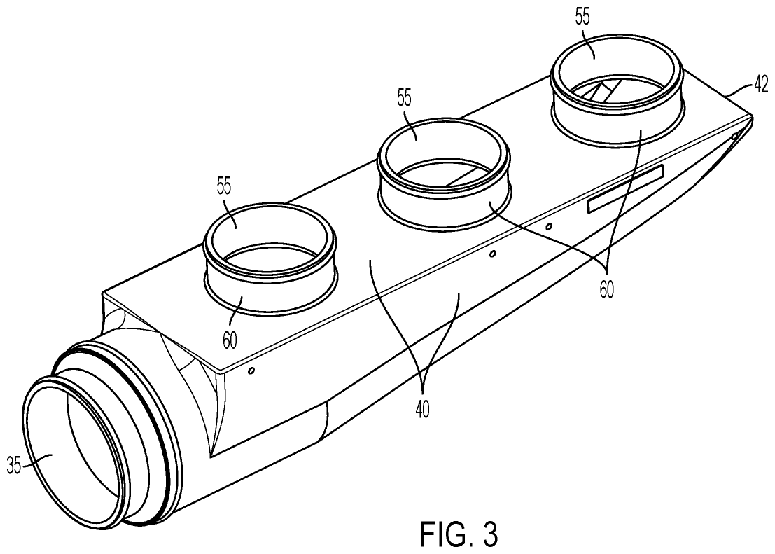

As shown in FIGS. 2-7, the AFA 20 includes a manifold 40 that increases in internal volume 44 from a distal end 42 to the outlet 35. The internal volume 44 of the manifold 40 is the area enclosed within the inside of the manifold 40. Illustrated in FIG. 3, the sectional view B-B shows the internal volume 44a of the manifold 40 near the distal end 42. Sectional view C-C shows the internal volume 44b of the manifold 40 near the support 50. Sectional view D-D shows the internal volume 44c of the manifold 40 near the outlet 35.

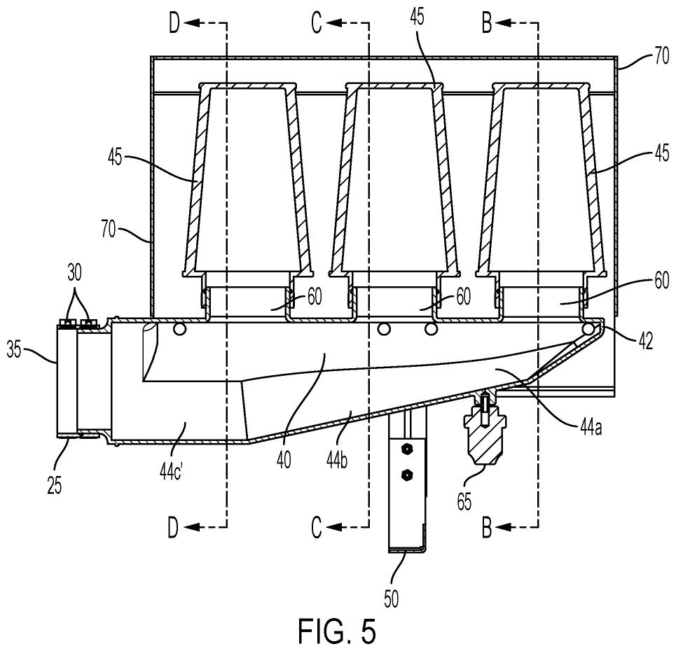

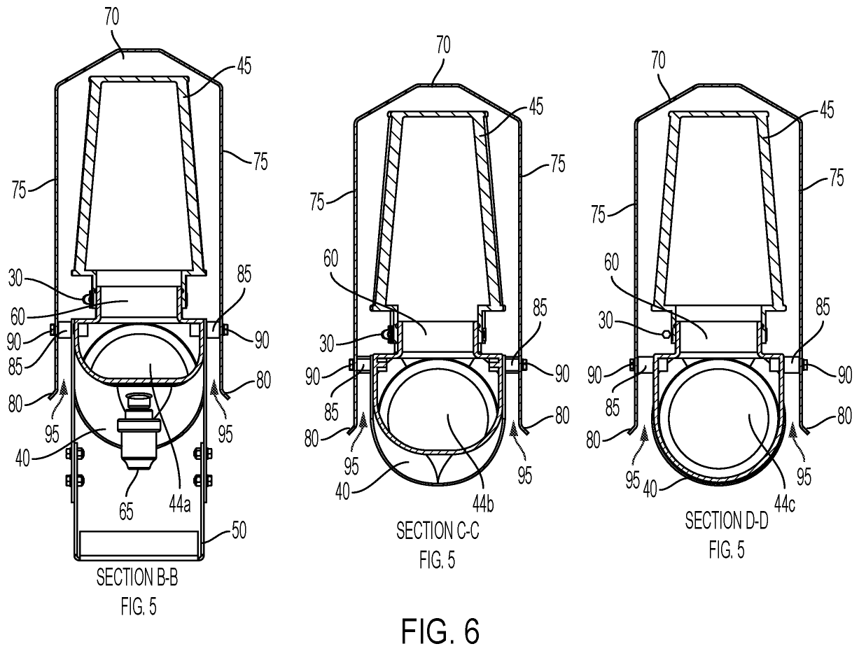

As shown in FIGS. 5-6, the manifold 40 tapers from the distal end 42 to the outlet 35 as described immediately above. That is, the internal volume 44 increases from 44a to 44b to 44c. This novel feature provides an increasing internal area that allows air entering each inlet 55 to smoothly flow to the outlet 35. The increasing internal volume 44 enables the velocity of the air to be held as constant as possible as it travels the length of the manifold 40, even though the volume of air increases along the length of the manifold 40 as air is drawn into the manifold 40 at each inlet 55. Keeping the air flow, or velocity as constant as possible within the manifold 40 minimizes a decrease in the air pressure, thereby maximizing a total volume or mass of air that exits the outlet 35 for delivery to the compressor 10. This novel feature of the AFA 20 greatly increases the efficiency of the compressor 10, thereby significantly reducing the energy required to operate the compressor 10.

Referring now to FIGS. 1-2 and 4-6, a clamp 30 removably couples a filter 45 to each flange 60 located at each inlet 55 of the manifold 40. In the illustrated embodiment, the manifold 40 includes three inlets 55 and three filters 45. However, it will be appreciated that the manifold 40 may employ one, two, four or more inlets 55 and filters 45, depending on requirements. In one embodiment, each filter 45 is manufactured by K&N, model RE-0870 (K&N is a registered trademark of K&N Engineering, Inc. of Riverside, Calif.). In another embodiment, each filter 45 manufactured by S&B Filters, model S&B RO861 (S&B is a registered trademark of S&B Filters, Inc. of Fontana, Calif.).

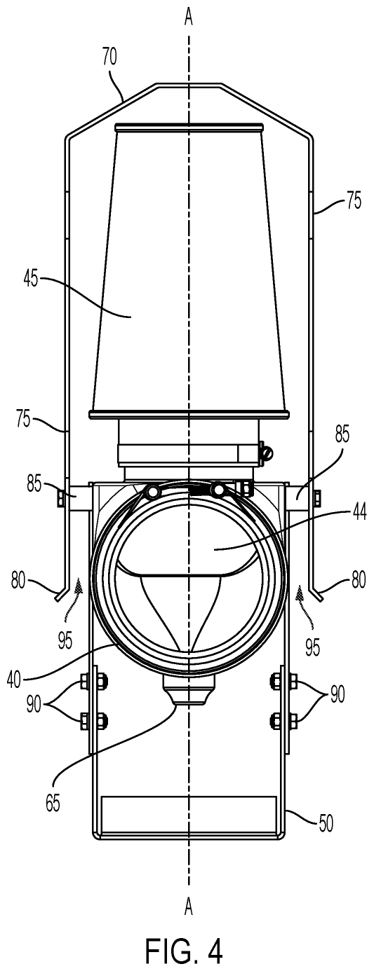

As shown in FIGS. 4-7, a vacuum gauge, or 65 is removably coupled to the manifold 40. In one embodiment, the vacuum gauge 65 is a visual vacuum gauge that allows a user to determine when to clean or replace the filters 45 as the vacuum inside the manifold 40 will increase proportional to the reduction of filter 45 effectiveness that generally accrues from accumulation of dirt or debris on the filter 45. It will be appreciated that many different types of vacuum gauges may be employed. For example, in one embodiment, a Filter Minder visual floating indicator vacuum gauge is employed (Filter Minder is a registered trademark of the Donaldson Company, Inc. of Bloomington, Minn.). However, other vacuum gauges may be used, including electronic gauges that wirelessly communicate their status to users who may be remote from the AFA 20.

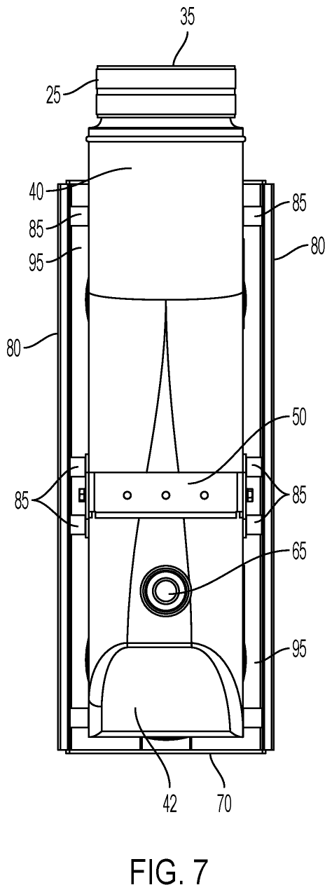

Referring now to FIGS. 1-2 and 4-7, a hood, or shroud 70 is removably coupled to the manifold 40. The hood 70 comprises two sides 75 that extend along the length of the manifold 40, two ends located at each end of the manifold 40 and a top that joins the sides 75 and ends. As shown, the hood 70 is positioned over the filters 45, thereby protecting them from the elements. Several spacers 85 and fasteners 90 removably couple the hood 70 to the manifold 40. The spacers 85 form a gap or opening 95 located between each side 75 of the hood 70 and the manifold 40. The gap 95 extends along the length of both sides of the manifold 40, as shown in FIGS. 6-7. Each side 75 of the hood 70 terminates with a flare, or lip 80 that extends away from the manifold 40.

The gap 95 directs ambient air to flow from the bottom of the sides 75, past the lip 80 and up into the hood 70 and then into each filter 45. The lip 80 is curved or shaped so that a flow of the air into the gap 95 is laminar, or non-turbulent. The gap 95 and lip 80 are sized so that a velocity of the air increases as it is drawn past the lip 80 and into the gap 95. By increasing the velocity, or speed of the air as it passes through the gap 95, noise that is generated by the compressor 10 is reduced. That is, one feature of the AFA 20 is that a width, or size of the gap 95 can be adjusted so that ambient air that is drawn past the lip 80 and into the gap 95 is accelerated. The accelerated air flow decreases the compressor 10 noise that is exiting through the gap 95. This is because noise, or sound is a pressure wave traveling through the air, and by accelerating the speed of the air as it enters the gap 95, the pressure of the air decreases, thereby decreasing the pressure wave, or sound exiting the gap 95. Also, ingestion of dust, debris and water is reduced by making ambient air enter the hood 70 from under the AFA 20.

Shown in FIGS. 1-2 and 4-7, the AFA 20 may include a support 50 that comprises a bracket or other apparatus designed to couple the AFA 20 to adjacent structure, for example, as shown in FIG. 1, the support 50 couples to the enclosure 15. The support 50 may include fasteners 90 or other elements so that the AFA 20 is securely mounted adjacent to the compressor 10. The support 50, manifold 40, hood 70 and other elements of the AFA 20 may be constructed of any number of different materials. For example, the materials may include composites, such as KEVLAR, or carbon fiber, and plastics, polyurethanes, polymers, polyesters, polyolefins, polycarbonates, polyamides, polyether, polyethylene, polytetrafluoroethylene, natural and synthetic rubbers, polyvinyl chloride, polystyrene, nylon, aluminum alloys and metal alloys (KEVLAR is a registered trademark of E.I. du Pont de Nemours and Company of Wilmington, Del.).

Thus, it is seen that an air filter apparatus is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the embodiments discussed in this description may practice the invention as well. That is, while the present invention has been described in conjunction with specific embodiments, it is evident that many alternatives, modifications, and variations will become apparent to those of ordinary skill in the art in light of the foregoing description. Accordingly, it is intended that the present invention embrace all such alternatives, modifications and variations as fall within the scope of the appended claims. The fact that a product exhibits differences from one or more of the above-described exemplary embodiments does not mean that the product is outside the scope (literal scope and/or other legally-recognized scope) of the following claims.

It is to be noticed that the term “comprising”, used in the claims, should not be interpreted as being limitative to the means listed thereafter. Thus, the scope of the expression “a device comprising means A and B” should not be limited to devices consisting only of components A and B. It means that with respect to the present invention, the only relevant components of the device are A and B. Similarly, it is to be noticed that the term “coupled”, also used in the claims, should not be interpreted as being limitative to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means. Also, “coupled” may mean attached in a fixed manner or attached so that relative movement between one or elements is possible. Finally, the terms “a”, “an” and “the” mean “one or more”, unless expressly specified otherwise.

1. An air filter apparatus, comprising:
a manifold comprising at least one compressible gas inlet and an outlet, where an internal volume of the manifold increases from a distal end of the manifold to the outlet; and
a shroud detachably mounted over the manifold so that a compressible gas can enter the shroud and pass through the at least one compressible gas inlet and through the outlet, where the shroud includes a top surface that is continuous and a bottom that is open so that the compressible gas enters the bottom of the shroud.

2. The apparatus of claim 1, further comprising a plurality of spacers located between the shroud and the manifold, the plurality of spacers forming a compressible gas passage located between the shroud and the manifold.

3. The apparatus of claim 1, further comprising a mounting element coupled to the manifold and sized to attach to a compressor motor enclosure.

4. The apparatus of claim 1, further comprising an adjustable sleeve sized to removably couple to the outlet and a compressor inlet.

5. The apparatus of claim 1, further comprising a filter element removably coupled to the at least one compressible gas inlet.

6. The apparatus of claim 1, further comprising a compressible gas vacuum indicator removably coupled to the manifold.

7. The apparatus of claim 1, where the shroud is removably positioned adjacent to the manifold so that a compressible gas passage is formed between the shroud and the manifold, with the compressible gas passage sized to increase a velocity of a compressible gas that passes through the compressible gas passage.

8. An air filter apparatus comprising:
a manifold comprising at least one compressible gas inlet and an outlet, where an internal volume of the manifold increases from a distal end of the manifold to the outlet; and
a shroud removably positioned adjacent to the manifold so that a compressible gas passage is formed between the shroud and the manifold so that a compressible gas can enter the compressible gas passage and flow into the at least one compressible gas inlet and exit through the outlet, where the shroud is rectangular in shape, with two sides longer than a front and a back, with a front of the shroud located adjacent to the manifold outlet, and where the front of the shroud lacks an aperture.

9. The apparatus of claim 8, further comprising a mounting element coupled to the manifold and sized to attach to a compressor motor enclosure.

10. The apparatus of claim 8, further comprising an adjustable sleeve sized to removably couple to the outlet and a compressor inlet.

11. The apparatus of claim 8, further comprising a filter element removably coupled to the at least one compressible gas inlet.

12. The apparatus of claim 8, further comprising a compressible gas vacuum indicator removably coupled to the manifold.

13. The apparatus of claim 8, where the compressible gas passage is sized to increase a velocity of a compressible gas that passes through the compressible gas passage.

14. An air filter apparatus comprising:
a manifold comprising a plurality of compressible gas inlets and an outlet, where an internal volume of the manifold increases from a distal end of the manifold to the outlet;
a plurality of spacers located between a shroud and the manifold, the plurality of spacers forming a compressible gas passage located between a side of the shroud and the manifold so that a compressible gas can enter the compressible gas passage and flow into the plurality of compressible gas inlets and exit the outlet, where the shroud includes a top surface that is continuous and a bottom that is open so that the compressible gas enters the bottom of the shroud.

15. The apparatus of claim 14, further comprising a plurality of filter elements removably coupled to the plurality of compressible gas inlets.

16. The apparatus of claim 14, further comprising a mounting element coupled to the manifold and sized to attach to a compressor motor enclosure.

17. The apparatus of claim 14, further comprising an adjustable sleeve sized to removably couple to the outlet and a compressor inlet.

18. The apparatus of claim 14, further comprising a compressible gas flow indicator removably coupled to the manifold.

19. The apparatus of claim 14, where the compressible gas passage is sized to increase a velocity of a compressible gas that passes through the compressible gas passage.
